(19) United States
(12) Patent Application Publication
(10) Pub. No.: US 2024/0309162 A1
(43) Pub. Date: Sep. 19, 2024

(54) PROCESS FOR PRODUCING IMPROVED RIGID POLYISOCYANURATE FOAMS BASED ON AROMATIC POLYESTER POLYOLS AND ETHYLENE OXIDE-BASED POLYETHER POLYOLS

(71) Applicant: BASF SE, Ludwigshafen Am Rhein (DE)

(72) Inventors: Tobias KALUSCHKE, Lemfoerde (DE); Sebastian KOCH, Lemfoerde (DE); Olaf JACOBMEIER, Lemfoerde (DE)

(21) Appl. No.: 18/693,252

(22) PCT Filed: Oct. 17, 2022
(86) PCT No.: PCT/EP22/78775

§ 371 Date: Mar. 19, 2024

(30) Foreign Application Priority Data
Oct. 18, 2021 (EP) 21203229.6

(51) Int. Cl. C08J 9/00; C08G 18/08; C08G 18/16; C08G 18/40; C08G 18/42; C08G 18/48; C08G 101/00; C08J 9/08; C08J 9/14

(52) U.S. Cl. CPC C08J 9/0038; C08G 18/14; C08G 18/161; C08G 18/4018; C08G 18/4213; C08G 18/4825; C08G 18/4837; C08J 9/0042; C08J 9/0061; C08J 9/08; C08J 9/141; C08G 2101/00; C08G 2110/0025; C08G 2330/00; C08J 2201/026; C08J 2203/02; C08J 2203/12; C08J 2203/14; C08J 2203/184; C08J 2205/10; C08J 2375/06

(57) ABSTRACT

The present invention relates to a process for producing rigid polyisocyanurate foams, wherein (A) polyisocyanates are mixed with (B) compounds having isocyanate-reactive hydrogen atoms, (C) flame retardants, (D) blowing agents, (E) catalyst at an isocyanate index of at least 220 to afford a reaction mixture and cured to afford the rigid polyisocyanurate foam, wherein the component (B) comprises at least one aromatic polyester polyol (b1) and at least one polyether polyol (b2), the polyester polyol (b1) has an average total functionality of ≤3.0 and ≥1.7 and the polyether polyol (b2) has a hydroxyl number of 160-350 mg KOH/g and is produced by alkoxylation of a starter or starter mixture having an average total functionality ≤3.5 and ≥1.5, wherein as the alkylene oxide for producing polyether polyol (b2) at least 80%by weight of ethylene oxide is employed and comprises at least 90% primary hydroxyl end groups and wherein the mass ratio of the component (b1) to component (b2) is ≤3 and ≥1 and the blowing agent (D) comprises chemical and physical blowing agents, wherein the chemical blowing agent is selected from the group consisting of formic acid-water mixtures and formic acid. The present invention further relates to a rigid polyisocyanurate foam obtainable by the process according to the invention.

### DESCRIPTION

The present invention relates to a process for producing rigid polyisocyanurate foams, wherein (A) polyisocyanates are mixed with (B) compounds having isocyanate-reactive hydrogen atoms, (C) flame retardants, (D) blowing agents, (E) catalyst and (F) optionally further auxiliary and additive substances at an isocyanate index of at least 220 to afford a reaction mixture and cured to afford the rigid polyisocyanurate foam, wherein the component (B) comprises at least one aromatic polyester polyol (b1) and at least one polyether polyol (b2), wherein the polyester polyol (b1) is produced by esterification of: (b1.1) 10 to 50 mol % of a dicarboxylic acid composition comprising aromatic dicarboxylic acids, (b1.2) 0 to 20 mol % of one or more fatty acids and/or fatty acid derivatives, (b1.3) 10 to 80 mol % of one or more aliphatic or cycloaliphatic diols having 2 to 18 carbon atoms or alkoxylates of same, (b1.4) 0 to 50 mol % of a higher-functional polyol selected from the group consisting of glycerol, alkoxylated glycerol, trimethylolpropane, alkoxylated trimethylolpropane, pentaerythritol, alkoxylated pentaerythritol, the total amount of the components (b1.1) to (b1.4) sums to 100 mol % and the polyester polyol (b1) has an average functionality of ≤3.0 and ≥1.7 and wherein the polyether polyol (b2) has a hydroxyl number of 160-350 mg KOH/g and is produced by alkoxylation of a starter or starter mixture having an average functionality ≤3.5 and ≥1.5, wherein as the alkylene oxide for producing polyether polyol (b2) at least 80% by weight of ethylene oxide is employed and polyether polyol (b2) comprises at least 90% primary hydroxyl end groups and wherein the mass ratio of the component (b1) to component (b2) is ≤3 and ≥1 and the sum of the mass fractions of component (b1) and component (b2), based on component (B), is >80% by weight and the blowing agent (D) comprises chemical and physical blowing agents, wherein the chemical blowing agent is selected from the group consisting of formic acid-water mixtures and formic acid. The present invention further relates to a rigid polyisocyanurate foam obtainable by the process according to the invention and to a polyol component for use in the process according to the invention.

Rigid polyurethane or polyisocyanurate foams have long been known. One important application is heat and cold insulation, for example in refrigeration apparatuses, in hot water storage means, in district heating pipes or in built structures, for example in composite elements made of outerlayers and a core of rigid polyurethane or polyisocyanurate foam, also known as sandwich elements. The production of such composite elements, in particular when using at least one metallic outerlayer, is currently practiced on a large scale, usually on continuously operating double-belt plants. As well as sandwich elements for cold warehouse insulation sandwich elements are becoming ever more important in the design of facades for a very wide variety of buildings.

The essential requirements of reaction mixtures for continuous production of sandwich elements based on rigid polyurethane or polyisocyanurate foam include allowing production of rigid foams having good mechanical properties, such as good compressive strengths, while nevertheless achieving low surface brittleness and good thermal insulation properties.

In addition the reaction mixtures for producing rigid polyurethane of polyisocyanurate foams are virtually always mixed with catalysts which make it possible to the markedly reduce the necessary fiber times. These are usually tertiary amines which are often questionable from a toxicological and ecological standpoint and are emitted from the foam in the course of time.

It is therefore desirable for reaction mixtures for producing rigid polyurethane or polyisocyanurate foams to exhibit low fiber times, and for these reaction mixtures to additionally allow rapid curing to afford the rigid foam, even at the lowest possible catalyst contents. Faster curing to afford the rigid foam has the result that said foam achieves the necessary stiffness required for cutting much earlier and therefore makes it possible for example to operate the continuously operating double-belt plants at higher speeds, thus achieving enhanced productivity in sandwich production. It is additionally known that faster reactivities and foam curing times ensure that finer foam cell diameters are obtained, thus having an advantageous effect on the insulation performance of the rigid foam.

It is also desirable for the obtained foams to achieve the necessary flame retardancy requirements at a lowest possible content of flame retardants which are likewise usually questionable from an ecological and toxicological standpoint.

Since flame retardant and catalysts are generally markedly more costly than polyols it is also desirable for economic reasons to keep the content of both components as low as possible.

Especially in continuous processing to produce sandwich elements it is also desired that the reaction mixtures afford rigid foams having a low surface foam brittleness to ensure good adhesion at the interface between the outerlayer and the rigid foam. In this regard it is known that rigid polyurethane foams which are typically produced at an isocyanate index of 120-160 generally have a markedly lower foam brittleness than rigid polyisocyanurate foams produced at an isocyanate index of >180. For this reason the continuous production of rigid polyisocyanurate foam composite elements generally comprises applying an adhesion promoter between the lower outerlayer and the foam in order to achieve outerlayer adhesions similar to rigid polyurethane foam composite elements. A great disadvantage of rigid polyurethane foams relative to rigid polyisocyanurate foams is that their reaction mixtures must comprise markedly greater proportions of often ecotoxicologically questionable flame retardants to meet the necessary flame retardancy requirements.

Polyisocyanurate foams based on polyester and polyethers are known. Thus, WO 2013139781 and WO13102540 describe polyisocyanurate foams, wherein the mass ratio of the employed polyesterols to polyetherols is at least 7.

According to WO 2013107573 the weight ratio of the employed polyester roles to polyether roles for producing the polyisocyanate from is less than 1.6. The preferably employed polyetherols consist of a mixture, wherein a portion of the polyether polyol is obtained by propoxylation, and the remainder by ethoxylation, of the starter molecule. The ethylene oxide-based polyether polyols preferably have functionalities of more than 4 and the propylene oxide-based polyetherols preferably have functionalities of less than 5.

EP3097132 discloses production of polyisocyanurate foams, wherein the polyol component comprises a polyether polyol having a hydroxyl number between 50 and 400 mg KOH/g obtained by reacting a polyfunctional initiator first with ethylene oxide and then with propylene oxide, so that the degree of propoxylation of the polyether polyol is between 0.33 and 2.

WO 2021008921, WO2012083038 und EP2184306 disclose polyisocyanurate from starting from a mixture of polyether polyol and polyester polyols as the isocyanate-reactive component, wherein the blowing agent employed is water.

The properties of the obtained rigid polyisocyanate foams of the prior art remain in need of improvement, in particular the curing characteristics, the fire characteristics and the brittleness of the foam surface.

It is accordingly an object of the present invention to improve the profile of properties of the rigid polyisocyanurate foams and in particular to provide rigid polyisocyanurate foams having exceptional mechanical properties, such as exceptional compressive strength coupled with reduced surface brittleness. Production thereof shall moreover be possible using a smallest possible amount of catalysts while still achieving a high reaction rate and curing and good fire resistance shall be achieved at low flame retardant proportions. It is a further object of the invention to develop a process for producing such rigid polyisocyanurate foams which is suitable for producing sandwich elements, in particular in a continuous production process.

This object is achieved by a rigid polyisocyanurate foam obtainable by a process wherein (A) polyisocyanates are mixed with (B) compounds having isocyanate-reactive hydrogen atoms, (C) flame retardants, (D) blowing agents, (E) catalyst and (F) optionally further auxiliary and additive substances at an isocyanate index of at least 220 to afford a reaction mixture and cured to afford the rigid polyisocyanurate foam, wherein the component (B) comprises at least one aromatic polyester polyol (b1) and at least one polyether polyol (b2), wherein the polyester polyol (b1) is produced by esterification of: (b1.1) 10 to 50 mol % of a dicarboxylic acid composition comprising aromatic dicarboxylic acids, (b1.2) 0 to 20 mol % of one or more fatty acids and/or fatty acid derivatives, (b1.3) 10 to 80 mol % of one or more aliphatic or cycloaliphatic diols having 2 to 18 carbon atoms or alkoxylates of same, (b1.4) 0 to 50 mol % of a higher-functional polyol selected from the group consisting of glycerol, alkoxylated glycerol, trimethylolpropane, alkoxylated trimethylolpropane, pentaerythritol, alkoxylated pentaerythritol, the total amount of the components (b1.1) to (b1.4) sums to 100 mol % and the aromatic polyester polyol (b1) has an average functionality of ≤3.0 and ≥1.7 and wherein the polyether polyol (b2) has a hydroxyl number of 160-350 mg KOH/g and is produced by alkoxylation of a starter or starter mixture having an average functionality ≤3.5 and ≥1.5, wherein as the alkylene oxide for producing polyether polyol (b2) at least 80% by weight of ethylene oxide is employed and polyether polyol (b2) comprises at least 90% primary hydroxyl end groups and wherein the mass ratio of the component (b1) to component (b2) is ≤3 and ≥1 and the sum of the mass fractions of component (b1) and component (b2), based on component (B), is >80% by weight and the blowing agent (D) comprises chemical and physical blowing agents, wherein the chemical blowing agent is selected from the group consisting of formic acid-water mixtures and formic acid.

A rigid polyisocyanate foam is generally understood as meaning a foam comprising both urethane and isocyanurate groups. In the context of the present invention the term rigid polyurethane foam shall also comprise rigid polyisocyanurate foam, wherein the production of rigid polyisocyanurate foams is based on an isocyanate index of at least 180. The isocyanate index is to be understood as meaning the ratio of isocyanate groups to isocyanurate reactive groups multiplied by 100. An isocyanate index of 100 corresponds to an equimolar ratio of the employed isocyanate groups of the component (A) to the isocyanate-reactive groups of the components (B) to (F).

Rigid polyisocyanurate foams according to the present invention have a compressive strength at 10% compression of not less than 80 kPa, preferably not less than 120 kPa, particularly preferably not less than 140 kPa. The isocyanate-based rigid foam according to the invention moreover has a closed cell content according to DIN ISO 4590 of more than 80%, preferably more than 90%. Further details of the rigid polyisocyanurate foams according to the invention may be found in “Kunststoffhandbuch, Band 7, Polyurethane”, Carl Hanser Verlag, 3rd edition 1993, chapter 6, in particular chapter 6.2.2 and 6.5.2.2.

The embodiments specified hereinbelow in the context of components (B) to (F) relate not only to the process according to the invention and the thus-obtainable rigid foams but also to the polyol components according to the invention.

### Component (A)

The polyisocyanates (A) are the aromatic polyfunctional isocyanates known in the prior art. Such polyfunctional isocyanates are known and may be produced by methods known per se. The polyfunctional isocyanates may in particular also be used as mixtures, so that the component (A) in this case comprises different polyfunctional isocyanates. Polyisocyanate (A) is a polyfunctional isocyanate having two (hereinbelow also referred to as diisocyanates) or more than two isocyanate groups per molecule. The isocyanates (A) are in particular selected from the group consisting of aromatic polyisocyanates, such as 2,4-and 2,6-toluene diisocyanate and the corresponding isomer mixtures, 4,4′-, 2,4′-and 2,2′-diphenylmethane diisocyanate and the corresponding isomer mixtures (also known as monomeric diphenylmethane or MMDI), for example mixtures of 4,4′-and 2,4′-diphenylmethane diisocyanates, mixtures of at least one isomer of diphenylmethane diisocyanate and higher-nuclear homologues of diphenylmethane diisocyanate which have at least 3 aromatic nuclei and a functionality of at least 3 and are also known as polyphenyl-polymethylene polyisocyanates or polymeric MDI. The isomers and homologues of MDI are generally obtained by distillation of crude MDI. In addition to dinuclear MDI (MMDI) polymeric MDI also comprises one or more polynuclear condensation products of MDI having a functionality of more than 2, in particular 3 or 4 or 5. Polymeric MDI is known and is often described as polyphenyl-polymethylene polyisocyanate. Also employable as isocyanate (A) are mixtures of 4,4′-, 2,4′-and 2,2′-diphenylmethane diisocyanates and polyphenylpolyethylene polyisocyanates (crude MDI) and mixtures of crude MDI and toluene diisocyanates. Particularly suitable are 2,2′-, 2,4′-or 4,4′-diphenylmethane diisocyanate (MDI) and mixtures of two or three of these isomers, 1,5-naphthylene diisocyanate (NDI), 2,4-and/or 2,6-toluene diisocyanate (TDI), 3,3′-dimethyldiphenyl diisocyanate, 1,2-diphenylethane diisocyanate and/or p-phenylene diisocyanate (PPDI).

Frequent use is also made of modified polyisocyanates, i.e. products obtained by chemical reaction of organic polyisocyanates and comprising at least two reactive isocyanate groups per molecule. Particular mention may be made of polyisocyanates comprising ester, urea, biuret, allophanate, carbodiimide, isocyanurate, uretdione, carbamate and/or urethane groups, often also together with unconverted polyisocyanates.

The polyisocyanates of the component (A) particularly preferably comprise 2,2′-MDI or 2,4′-MDI or 4,4′-MDI or mixtures of monomeric diphenylmethane diisocyanate or mixtures of monomeric diphenylmethane diisocyanate and higher-nuclear homologues of MDI. The average functionality of a polyisocyanate comprising polymeric MDI may vary in the range from about 2.2 to about 4, preferably from 2.4 to 3.8 and in particular from 2.6 to 3.0. Polyfunctional isocyanates or mixtures of two or more MDI-based polyfunctional isocyanates are known and are commercially available from BASF Polyurethanes GmbH under the trade names Lupranat® M20, Lupranat® M50, oder Lupranat® M70.

The component (A) preferably comprises at least 70% by weight, particularly preferably at least 90% by weight and in particular 100% by weight, based on the total weight of the component (A), of one or more isocyanates selected from the group consisting of 2,2′-MDI, 2,4′-MDI, 4,4′MDI and higher-nuclear homologues of MDI. The content of higher-nuclear homologues of MDI is preferably at least 20% by weight, particularly preferably more than 30% to less than 80% by weight, based on the total weight of the component (A).

The viscosity of the employed component (A) may be varied over a wide range. The component (A) preferably has a viscosity of 100 to 3000 mPa*s, particularly preferably from 100 to 1000 mPa*s, particularly preferably from 100 to 800 mPa*s, particularly preferably from 200 to 700 mPa*s and particularly preferably from 400 to 650 mPats at 25° C. and results from the choice of the isocyanates (A) and the mixtures thereof.

### Component (B)

The employed isocyanate-reactive compounds (B) may be selected from any compounds having isocyanate-reactive groups known in polyurethane chemistry, preferably compound having on average at least 1.5 isocyanate-reactive groups, such as hydroxyl groups, —NH groups, NH2 groups or carboxylic acid groups, preferably NH2 or OH groups and in particular at least 1.5 OH groups. The average functionality of the compounds of the component (B) towards isocyanate groups is in the range from at least 1.5, preferably 1.6 to 8.0, particularly preferably 1.7 to 3.0 and in particular 1.8 to 2.5.

The compounds having at least two isocyanate-reactive hydrogen atoms (B) comprise at least one aromatic polyester polyol (b1) and at least one polyether polyol (b2), wherein the mass ratio of the component (b1) to component (b2) is ≤3 and ≥1 and the sum of the mass fractions of component (b1) and component (b2) based on component (B) is >80% by weight.

For the purposes of the present disclosure, the expressions “polyester polyol” and “polyesterol” are equivalent, as also are the expressions “polyether polyol” and “polyetherol”.

According to the invention the component (B) comprises at least one aromatic polyester polyoll (b1) producible by esterification of (b1.1) 10 to 50 mol % of a dicarboxylic acid composition comprising aromatic dicarboxylic acids, (b1.2) 0 to 20 mol % of one or more fatty acids and/or fatty acid derivatives, (b1.3) 10 to 70 mol % of one or more aliphatic or cycloaliphatic diols having 2 to 18 carbon atoms or alkoxylates thereof, (b1.4) 0 to 50 mol % of a higher-functional polyol selected from the group consisting of glycerol, alkoxylated glycerol, trimethylolpropane, alkoxylated trimethylolpropane, pentaerythritol, alkoxylated pentaerythritol.

The dicarboxylic acid composition (b1.1) comprises dicarboxylic acids and/or derivatives thereof which may typically be used for producing esters. The dicarboxylic acid composition (b1.1) preferably comprises at least one compound selected from the group consisting of terephthalic acid, dimethyl terephthalate (DMT) polyethylene terephthalate (PET), phthalic acid, phthalic anhydride (PSA) and isophthalic acid. It is particularly preferable when the component (b1.1) comprises phthalic anhydride, phthalic acid, terephthalic acid or polyethylene terephthalate (PET) and in particular phthalic anhydride or terephthalic acid, in particular phthalic anhydride. Component (b1.1) may generally also comprise aliphatic dicarboxylic acids or aliphatic dicarboxylic acid derivatives. If aliphatic dicarboxylic acids are used these are generally present in amounts of 0.5-30 mol %, preferably 0.5 to 10 mol %, in each case based on the component (b1.1). The aliphatic dicarboxylic acids employed preferably include adipic or dicarboxylic acid mixtures of succinic, glutaric and adipic acid. It is preferable when the dicarboxylic acid composition (b1.1) comprises no aliphatic dicarboxylic acids and thus consists to an extent of 100 mol % of one or more aromatic dicarboxylic acids or derivatives thereof.

Component (b1.1) is generally employed in amounts of 10 to 50 mol %, preferably in amounts of 20 to 45 mol %, based on the components (b1.1), (b1.2), (b1.3) and (b1.4) used for producing the aromatic polyester polyol (b1).

It is also possible to use one or more fatty acids and/or fatty acid derivatives (b1.2) for producing the aromatic polyester polyol (b1). The acids and/or fatty acid derivatives may be of either biological or petrochemical origin. Examples of fatty acids are caproic acid, caprylic acid, capric acid, lauric acid, myristic acid, myristoleic acid, palmitic acid, palmitoleic acid, stearic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid, cervonic acid, ricinoleic acid and mixtures thereof. Examples of fatty acid derivatives are glycerol esters of fatty acids, for example castor oil, grapeseed oil, black cumin oil, pumpkin kernel oil, borage seed oil, soybean oil, wheat germ oil, rapeseed oil, sunflower seed oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil.

Further examples of fatty acid derivatives are hydroxyl-modified fats or fatty acids, hydrogenated fats or fatty acids, epoxidized facts acids, alkyl-branched or fatty acid, fatty acid amides, animal tallow such as for example beef tallow, alkyl or especially methyl esters of fatty acids such as biodiesel.

Component (b1.2) is generally employed in amounts of 0 to 20 mol %, preferably in amounts of 5 to 15 mol %, particularly preferably in amounts of 6 to 10 mol %, based on all components (b1.1) to (b1.4) used for producing the aromatic polyester polyol (b1).

In a particularly preferred embodiment of the present invention the fatty acid or the fatty acid derivative (b1.2) is oleic acid, biodiesel, soybean oil, rapeseed oil or tallow, in particular oleic acid or biodiesel, especially oleic acid, and is used in an amount of 5 to 15 mol %. The fatty acid or the fatty acid derivative improves inter alia blowing agent solubility in the production of rigid polyurethane or polyisocyanurate foams. It is very particularly preferable when component (b1.2) comprises no triglyceride, in particular no oil or fat. The glycerol liberated through esterification or transesterification from the triglyceride impairs the dimensional stability of the rigid foam.

The component (b1.3) employed is one or more aliphatic or cycloaliphatic diols having 2 to 18 carbon atoms or alkoxylates thereof. Component (b1.3) preferably comprises at least one compound from the group consisting of ethylene glycol, diethylene glycol, propylene glycol, 1,3-propanediol, 1,4-butanediol, 1,5-pentanediol, 1,6-hexanediol, 2-methyl-1,3-propanediol and 3-methyl-1,5-pentanediol and alkoxylates thereof. The aliphatic diol (b1.3) is particularly preferably monoethylene glycol or diethylene glycol, in particular diethylene glycol. Component (b1.3) is generally employed in amounts of 10 to 80 mol %, preferably in amounts of 20 to 75 mol %, particularly preferably in amounts of 30 to 60 mol %, based on all components used for producing the aromatic polyester polyol (b1).

Suitable higher-functional polyols (b1.4) that may be employed for producing the aromatic polyester polyol (b1) include any desired polyols having a functionality of more than 2. The higher-functional polyol (b1.4) is preferably selected from the group consisting of glycerol, alkoxylated glycerol, trimethylolpropane, alkoxylated trimethylolpropane, pentaerythritol, alkoxylated pentaerythritol and mixtures of 2 or more of these higher-functional polyols. The higher-functional polyol (b1.4) is preferably glycerol, alkoxylated glycerol or mixtures thereof.

The higher-functional polyol (b1.4) is employed in amounts of 0 to 50 mol %, preferably in amounts of 5 to 40 mol %, particularly preferably in amounts of 10 to 25 mol %, based on all components used for producing the aromatic polyester polyol (b1). In a particularly preferred embodiment of the present invention no higher-functional polyol (b1.4) is used for producing the aromatic polyester.

According to the invention the aromatic polyester polyol (b1) has a number-average functionality of ≥1.7 to ≤3.0, preferably of ≥1.7 to ≤2.5, particularly preferably of ≥1.75 to ≤2.2.

The aromatic polyester polyol (b1) preferably has a hydroxyl number of 190 to 250 mg KOH/g, preferably of 200 to 240 mg KOH/g.

In a particularly preferred embodiment the aromatic polyester polyol (b1) as an OH number of 190 to 250 mg KOH/g and a functionality of 1.7 to 2.5.

To produce the aromatic polyester polyol (b1) the dicarboxylic acids (b1.1), fatty acids and/or fatty acid derivatives (b1.2), the aliphatic or cycloaliphatic diols 2 to 18 carbon atoms or alkoxylates thereof (b1.3) and the higher-functional polyols (b1.4) may be subjected to polycondensation in the melt at temperatures of 150° C. to 280° C., preferably 180° C. to 260° C., optionally under reduced pressure up to the desired acid number which is advantageously less than 10 and particularly preferably less than 2 in the absence of catalyst or preferably in the presence of esterification catalysts, advantageously in an atmosphere of inert gas such as nitrogen. In a preferred embodiment the esterification mixture is subjected to polycondensation at the abovementioned temperatures up to an acid number of 80 to 20, preferably 40 to 20, under standard pressure and subsequently at a pressure of less than 500 mbar, preferably 40 to 400 mbar. Suitable as esterification catalysts are, for example, iron, cadmium, cobalt, lead, zinc, antimony, magnesium, titanium and tin catalysts in the form of metals, metal oxides or metal salts. However, the polycondensation may also be carried out in the liquid phase in the presence of diluents and/or entraining agents, for example benzene toluene, xylene or chlorobenzene for azeotropic distillative removal of the water of condensation.

The proportion of the polyester polyols (b1) according to the invention is generally at least 20% by weight, preferably at least 30% by weight, particularly preferably at least 40% by weight and especially at least 50% by weight based on sum of the components (B) to (F).

According to the invention component (B) comprises not only the polyester polyol (b1) but also at least one polyether polyol (b2) which has a hydroxyl number of 160-350 KOH/g and is produced by alkoxylation of a starter or start the mixture, wherein the alkylene oxide employed for producing polyether polyol (b2) is preferably at least 80% by weight of ethylene oxide and polyether polyol (b2) comprises at least 90%, preferably at least 95%, particularly preferably at least 99% and in particular exclusively primary hydroxyl end groups.

The polyether polyols (b2) are produced by known processes, for example by anionic polymerization of one or more alkylene oxides having 2 to 4 carbon atoms, comprising ethylene oxide, with customary catalysts, such as alkali metal hydroxides, such as sodium or potassium hydroxide, alkali metal alkoxides, such as sodium methoxide, sodium or potassium ethoxide or potassium isopropoxide, or aminic alkoxylation catalysts, such as dimethylethanolamine (DMEOA), imidazole and/or imidazole derivatives, using at least one starter molecule or starter molecule mixture comprising on average ≤3.5 and ≥1.5, preferably ≤3.0 and ≥2.0 and particularly preferably 2 reactive hydrogen atoms in bonded form. In addition to the anionic polymerization of the starter molecules production may also be ecarried out using cationic polymerization, wherein catalysts employed include Lewis acids, such as antimony pentachloride, boron fluoride etherate or fuller's earth.

Preferred alkoxylation catalysts are KOH and aminic alkoxylation catalysts. Since the use of KOH as alkoxylation catalyst requires that the polyether must initially be neutralized and the resulting potassium salt separated the use of aminic alkoxylation catalyst is particularly preferred. Preferred aminic alkoxylation catalysts are selected from the group comprising dimethylethanolamine (DMEOA), imidazole and imidazole derivatives, and also mixtures thereof, particularly preferably imidazole.

In addition to ethylene oxide suitable alkylene oxides also include for example tetrahydrofuran, 1,3- and 1,2-propylene oxide, 1,2- and 2,3-butylene oxide, styrene oxide and preferably 1,2-propylene oxide. In a particularly preferred embodiment the alkylene oxide employed is exclusively ethylene oxide. The alkylene oxides may be used individually, alternately in succession or as mixtures. According to the invention the alkylene oxide used for producing polyether polyol (b2) is at least 80% by weight of ethylene oxide, preferably at least 90% by weight of ethylene oxide, particularly preferably at least 95% by weight and especially at least 98% by weight of ethylene oxide. The alkylene oxide used for producing the polyether polyol (b2) according to the invention is very particularly preferably exclusively ethylene oxide, i.e. the weight fraction of ethylene oxide in the total weight of alkylene oxide in component (b2) is 100% by weight in this embodiment. When ethylene oxide is employed in a mixture with other alkylene oxides it is to be ensured according to the invention that the polyether polyol produced therefrom comprises the inventive content of primary hydroxyl end groups.

Examples of useful starter molecules include: water, organic dicarboxylic acids, such as succinic acid, adipic acid, phthalic acid and terephthalic acid, aliphatic and aromatic, optionally N-mono-, N,N-and N,N′-dialkyl-substituted diamines having 1 to 4 carbon atoms in the alkyl radical, such as optionally mono-and dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, phenylenediamines, 2,3-, 2,4-and 2,6-tolylenediamine and 4,4′-, 2,4′- and 2,2′-diaminodiphenylmethane. The recited by primary amines are particularly preferred, preferably ethylenediamine. Useful starter molecules further include: alkanolamines, for example ethanolamine, N-methyl-and N-ethylethanolamine, dialkanolamines, for example diethanolamine, N-methyl und N-ethyldiethanolamine and trialkanolamines, for example triethanolamine, and ammonia.

It is preferable to employ di-or polyhydric alcohols, such as ethanediol, 1,2- and 1,3-propanediol, diethylene glycol (DEG) dipropylene glycol, 1,4-butanediol, 1,6-hexanediol, glycerol, trimethylolpropane, bisphenol A, bisphenol F, pentaerythritol, sorbitol and sucrose, particularly preferably diethylene glycol, monoethylene glycol, 1,2-propanediol and glycerol, especially diethylene glycol.

In a preferred embodiment the starter molecules comprise no fatty acids.

According to the invention the polyether polyol (b2) has a hydroxyl number of 160-350 mg KOH/g, preferably of 170-290 mg KOH/g, particularly preferably 175-225 mg KOH/g.

The proportion of the component (b2) is generally from 20% to 45% by weight, preferably from 25% to 40% by weight, particularly preferably from 30% to 38% by weight, based on the sum of the weight fractions of (B) to (F).

According to the invention the mass ratio of the component (b1) to component (b2) is ≤3 and ≥1, preferably ≤2.5 and ≥1.15 and particularly preferably ≤2.0 and ≥1.3.

According to the invention the sum of the mass fractions of component (b1) and component (b2) based on component (B) >80% by weight, preferably >90% by weight, particularly preferably >95% by weight. It is very particularly preferable when the sum of the mass fractions of component (b1) and component (b2) based on the component (B) is 100% by weight, i.e. in this embodiment no further compounds having isocyanate-reactive hydrogen atoms are employed as component (b1) and component (b2).

### Component (C)

Employable flame retardants E) generally include the flame retardants known from the prior art. Suitable flame retardants are for example brominated esters, brominated ethers (Ixol) or brominated alcohols such as dibromoneopentyl alcohol, tribromoneopentyl alcohol and PHT-4-diol and also chlorinated phosphates such as tris(2-chloroethyl) phosphate, tris(2-chloropropyl) phosphate (TCPP), tris(1,3-dichloropropyl) phosphate, tricresyl phosphate, tris(2,3-dibromopropyl) phosphate, tetrakis(2-chloroethyl) ethylenediphosphate, dimethylmethane phosphonate, diethyl diethanolaminomethylphosphonate and also commercially available halogen-containing flame-retardant polyols. Other phosphates or phosphonates used can comprise diethyl ethanephosphonate (DEEP), triethyl phosphate (TEP), dimethyl propylphosphonate (DMPP), and diphenyl cresyl phosphate (DPC) as liquid flame retardants. In the context of the present invention compounds which comprise phosphorus, chlorine or bromine atoms and also comprise isocyanate-reactive groups are not considered compounds having isocyanate-reactive hydrogen atoms (B) and not included in the calculation of the molar ratios of the component (B).

Also employable for endowing the rigid polyisocyanate foams with flame retardancy in addition to the abovementioned flame retardants are inorganic or organic flame retardants, such as red phosphorus, red phosphorus-containing preparations, aluminum oxide hydrate, antimony trioxide, arsenic oxide, ammonium polyphosphate and calcium sulfate, expandable graphite or cyanuric acid derivatives, for example melamine, or mixtures of at least two flame retardants, for example ammonium polyphosphates and melamine and also optionally corn starch or ammonium polyphosphate, melamine, expandable graphite and optionally aromatic polyesters. Preferred flame retardants comprise no isocyanate-reactive groups. It is preferable that the flame retardants are liquid at room temperature. Preferred flame retardants are TCPP, DEEP, TEP, DMPP and DPK, particularly preferably TCPP and TEP, in particular TCPP.

The proportion of the flame retardant (C) is generally 1% to 20% by weight, preferably 2% to 15% by weight, particularly preferably 3% to 10% by weight, based on the sum of the weight fractions of components (B) to (F).

Component (C) preferably comprises a phosphorus-containing flame retardant and the content of phosphorus, based on the total weight of the components (A) to (F), is <0.4% by weight, preferably <0.3% by weight and particularly preferably <0.2% by weight.

### Component (D)

Blowing agents (D) used for producing the rigid polyisocyanurate foams according to the invention include formic acid and formic acid-water mixtures. These react with isocyanate groups to form carbon dioxide and carbon monoxide. Since these blowing agents liberate the gas via a chemical reaction with the isocyanate groups they are referred to as chemical blowing agents. Physical blowing agents, such as low-boiling hydrocarbons, are employed in addition. Suitable physical blowing agents include in particular liquids which are inert toward the polyisocyanates (A) and have boiling points below 100° C., preferably below 50° C., at atmospheric pressure and therefore evaporate under the influence of the exothermic polyaddition reaction.

Employable physical blowing agents include for example alkanes, such as heptane, hexane, n- and isopentane, preferably industrial mixtures of n-pentane and isopentane, n-butane and isobutane and propane, cycloalkanes, such as cyclopentane and/or cyclohexane, ethers, such as furan, dimethyl ether and diethyl ether, ketones, such as acetone and methyl ethyl ketone, alkyl carboxylates, such as methyl formate, dimethyl oxalate and ethyl acetate and halogenated saturated and unsaturated hydrocarbons, such as methylene chloride, dichloromonofluoromethane, difluoromethane, trifluoromethane, difluoroethane, tetrafluoroethane, chlorodifluoroethane, 1,1dichloro-2,2,2-trifluoroethane, 2,2-dichloro-2-fluoroethane and heptafluoropropane and unsaturated hydrocarbons, such as trifluoropropenes and tetrafluoropropenes, such as (HFO-1234), pentafluoropropenes, such as (HFO-1225), chlorotrifluoropropenes, such as (HFO-1233), chlorodifluoropropenes, chlorotetrafluoropropenes and hexafluorobutenes, and also mixtures of one or more of these components. Preference is given to tetrafluoropropenes, pentafluoropropenes, chlorotrifluorpropenes and hexafluorobutenes, wherein the unsaturated, terminal carbon atom bears at least one chloro or fluoro substituent. Examples include 1,3,3,3-tetrafluoropropene (HFO-1234ze); 1,1,3,3-tetrafluoropropene; 1,2,3,3,3-pentafluoropropene (HFO-1225ye); 1,1,1trifluoropropene; 1,1,1,3,3-pentafluoropropene (HFO-1225zc); 1,1,2,3,3-pentafluoropropene (HFO-1225yc); 1-chloro-2,3,3,3-tetrafluorpropene (HFO-1224 yd); 1,1,1,2,3-pentafluoropropene (HFO-1225yez); 1-chloro-3,3,3-trifluoropropene (HCFO-1233zd); 1,1,1,4,4,4-hexafluorobut-2ene (HFO-1336mzz). It is also possible to use mixtures of these low-boiling-point liquids with one another and/or with other substituted or unsubstituted hydrocarbons.

Also suitable are organic carboxylic acids, for example formic acid, acetic acid, oxalic acid, ricinoleic acid and carboxyl-containing compounds.

Preference is given to no halogenated hydrocarbons being used as blowing agents. Chemical blowing agent employed include acid-water mixtures or formic acid. Physical blowing agents used are preferably pentane isomers/mixtures of pentane isomers. The chemical blowing agents are used together with physical blowing agents, wherein the use of formic acid-water mixtures or pure formic acid together with pentane isomers or mixtures of pentane isomers are preferred.

The employed amount of the blowing agent/the blowing agent mixture is 0.1% to 45% by weight, preferably 1% to 30% by weight, particularly preferably 1% to 20% by weight and in particular 1.5% to 20% by weight, in each case based on the sum of the components (B) to (F).

Formic acid or a formic acid-water mixture is preferably employed in an amount of 0.2% to 10% by weight, in particular in an amount of 0.5% to 4% by weight, based on the component (B). When formic acid-water mixtures are employed the proportion of formic acid, based on the total weight of formic acid and water, is preferably greater than 40% by weight, particularly preferably 50% to 98% by weight, more preferably 70% to 95% by weight and in particular 80% to 90% by weight. It is particularly preferable to employ formic acid or a formic acid-water mixture as the chemical blowing agent in combination with pentane.

### Component (E)

Catalysts (E) used for producing the rigid polyisocyanurate foams according to the invention are in particular compounds which markedly accelerate the reaction of the compounds comprising reactive hydrogen atoms, in particular hydroxyl groups, of the components (B) to (F) with the polyisocyanates (A).

Advantageously employed compounds include for example basic polyurethane catalysts, for example tertiary amines, such as triethylamine, tributylamine, dimethylbenzylamine, dicyclohexyl-methylamine, dimethylcyclohexylamine, N,N,N′,N′-tetramethyldiaminodiethyl ether, bis(dimethyl-aminopropyl)urea, N-methyl- or N-ethylmorpholine, N-cyclohexylmorpholine, N,N,N′,N′-tetramethylethylenediamine, N,N,N,N-tetramethylbutanediamine, N,N,N,N-tetramethylhexane-1,6-diamine, pentamethyldiethylenetriamine, bis(2-dimethylaminoethyl) ether, dimethylpiperazine, N-dimethylaminoethylpiperidine, 1,2-dimethylimidazole, 1-azabicyclo(2,2,0)octane, 1,4-diazabi-cyclo(2,2,2)octane (Dabco) and alkanolamine compounds, such as triethanolamine, triisopropanolamine, N-methyl-and N-ethyldiethanolamine, dimethylaminoethanol, 2-(N,N-dimethylaminoethoxy)ethanol, N,N′,N″-tris(dialkylaminoalkyl)hexahydrotriazine, for example N,N′,N″-tris(di-methylaminopropyl)-s-hexahydrotriazine and triethylenediamine.

However, further suitable catalysts include metal salts, such as iron(II) chloride, zinc chloride, lead octoate and tin salts, such as tin dioctoate, tin diethylhexoate and dibutyltin dilaurate and mixtures of tertiary amines and metal salts, in particular organic tin salts. Contemplated catalysts further include: amidines, such as 2,3-dimethyl-3,4,5,6-tetrahydropyrimidine, tetraalkylammonium hydroxides, such as tetramethylammonium hydroxide, alkali metal hydroxides, such as sodium hydroxide and alkali metal alkoxides, such as sodium methoxide and potassium isopropoxide, alkali metal carboxylates, and alkali metall salts of long-chain fatty acids having 8 to 20 carbon atoms and optionally pendant OH-Gruppen.

Contemplated catalysts further include incorporable amines, preferably amines having an —OH, —NH or —NH2 function, for example ethylenediamine, triethanolamine, diethanolamine, ethanolamine and dimethylethanolamine. Incorporable catalysts may be regarded as compounds of the component (B) as well as compounds of the component (E).

It is also possible to carry out the reactions without catalysis. In this case, it is usual to utilize the catalytic activity of amine-started polyols.

Contemplated catalysts for the trimerization reaction of the excess NCO groups with one another further include: isocyanurate-forming catalysts, for example ammonium ion salts or alkali metal salts, especially ammonium carboxylates or alkali metal carboxylates, alone or in combination with tertiary amines. Formation of isocyanurate leads to flame-retardant PIR foams which are preferably used in rigid foam for technical applications, for example in the construction industry as insulation sheet or sandwich elements.

In a preferred embodiment the catalyst (E) comprises an amine catalyst having a tertiary amino group and an ammonium or alkali metal carboxylate catalyst. In a particularly preferred embodiment the catalyst (E) comprises at least one amine catalyst selected from the group consisting of pentamethyldiethylenetriamine and bis(2-dimethylaminoethyl) ether and at least one alkali metal carboxylate catalyst selected from the group consisting of potassium formate, potassium acetate and potassium 2-ethylhexanoate. It has surprisingly been found that the use of these catalysts in the continuous production of sandwich elements, for example in a double-belt process, affords sandwich elements having a particularly smooth surface area facing the outer-layer, in particular the lower outerlayer. This results in sandwich elements having exceptional adhesion of the foam to the outer layer and in defect-free surfaces.

It is preferable to employ 0.001 to 10 parts by weight of catalysts/catalyst combination based on 100 parts by weight of the component (B).

### Component (F)

The reaction mixture for producing the polyisocyanate foam according to the invention may optionally also be admixed with further auxiliaries and/or additives (F). These include for example surface-active substances, foam stabilizers, cell regulators, fillers, light stabilizers, dyes, pigments, anti-hydrolysis agents, fungistatic and bacteriostatic substances.

Examples of surface-active substances that can be used are compounds which serve to support homogenization of the starting materials and which optionally are also suitable for regulating the cell structure of the plastics. Examples include emulsifiers, such as the sodium salts of castor oil sulfates or of fatty acids and salts of fatty acids with amines, for example diethylamine oleate, diethanolamine stearate, diethanolamine ricinoleate, salts of sulfonic acids, for example alkali metal or ammonium salts of dodecylbenzenedisulfonic acid or dinaphthylmethanedisulfonic acid and ricinoleic acid, foam stabilizers, such as siloxane oxyalkylene mixed polymers and other organopolysiloxanes and dimethylpolysiloxanes. Also suitable for improving emulsifying action, cell structure and/or stabilization of the foam are oligomeric acrylates having polyoxyalkylene and fluoroalkane radicals as side groups. The surface-active substances are typically employed in amounts of 0.01 to 10 parts by weight based on 100 parts by weight of the component (B). Foam stabilizers used may be customary foam stabilizers, for example those based on silicone, such as siloxane oxyalkylene mixed polymers and other organopolysiloxanes.

Fillers, in particular reinforcing fillers, are to be understood as meaning the customary organic and inorganic fillers, reinforcers, weighting agents, agents for improving abrasion characteristics in paints, coating agents etc. which are known per se. These especially include for example: inorganic fillers such as silicious minerals, for example phyllosilicates such as antigorite, serpentine, hornblendes, amphiboles, chrysotile and talc, metal oxides such as kaolin, aluminum oxides, titanium oxides and iron oxides, metal salts, such as chalk, barite and inorganic pigments such as cadmium sulfide and zinc sulfide and also glass inter alia. It is preferable to use kaolin (china clay), aluminum silicate and coprecipitates of barium sulfate and aluminum silicate, and also natural and synthetic fibrous minerals, for example wollastonite, and fibers of various lengths made of metal and in particular of glass; these can optionally have been sized. Contemplated organic fillers include for example: carbon, melamine, colophony, cyclopentadienyl resins and graft polymers and also cellulose fibers, polyamide fibers, polyacrylonitrile fibers, polyurethane fibers and polyester fibers based on aromatic and/or aliphatic dicarboxylic esters and in particular carbon fibers. The inorganic and organic fillers may be used individually or as mixtures and are advantageously added to the reaction mixture in amounts of 0.5% to 50% by weight, preferably 1% to 40% by weight, based on the weight of the components (A) to (F) but wherein the content of mats, nonwoven and woven fabrics made of natural and synthetic fibers may achieve values of up to 80% by weight based on the weight of the components (A) to (F).

According to the invention the production of the rigid polyisocyanurate foams according to the invention is carried out by mixing the components (A) to (E) and, if present, (F) to afford a reaction mixture. Premixtures may also be produced to reduce complexity. These comprise at least one isocyanate component comprising polyisocyanates (A) and a polyol component comprising isocyanate-reactive compounds (B). All or some of the further components (C) to (F) may be added to the isocyanate component and polyol component in whole or in part, wherein due to the high reactivity of the isocyanate in many cases the components (C) to (F) are added to the polyol component to avoid side reactions. However physical blowing agents in particular may also be admixed with the isocyanate component (A). Formic acid-water mixtures or formic acid are generally are generally present in the polyol component in entirely or partially dissolved form and the physical blowing agent (for example pentane) and optionally the remainder of the chemical blowing agent are added by direct “online” metering during production. The physical blowing agents are preferably supplied to the reaction mixture online in an extra stream and the remaining components (C), (E) and (F) are particularly preferably added to the polyol component. The catalyst is generally metered online but may also be present in the polyol component in partially or completely dissolved form.

The polyol component for producing the rigid polyisocyanurate foams according to the invention preferably comprises 70% to 90% by weight of the compounds having at least 1.5 isocyanate-reactive hydrogen atoms (B), 2% to 10% by weight of flame retardant (C), 1% to 20% by weight of blowing agent (D), 0.5% to 10% by weight of catalysts (E) and 0.0% to 20% by weight of further auxiliary and additive substances (F), in each case based on the total weight of the components (B) to (F). In a particularly preferred embodiment the proportions of the components (B) to (F) sum to 100% by weight.

The reaction mixture is subsequently reacted to afford the rigid polyisocyanurate foam. In the context of the present invention a reaction mixture is to be understood as meaning the mixture of the polyisocyanates (A) with the isocyanate-reactive compounds (B) and all further components (C), (D), (E) and optionally (F) at reaction conversions of less than 90% based on the isocyanate groups.

The mixing of the components to afford the reaction mixture is carried out at an isocyanate index of 220 to 1000, preferably at 260 to 800, preferably at 300 to 600, particularly preferably at 340 to 500. The starting components are mixed at a temperature of 15° C. to 90° C., preferably 20° C. to 60° C., in particular 20° C. to 45° C. The reaction mixture may be mixed by mixing in high- or low-pressure metering machines.

The reaction mixture may be introduced into a mold for example for the reaction to progress to completion. Discontinuous sandwich elements for example are produced by this technology. The rigid foams according to the invention are preferably produced on continuous double-belt plants. The polyol and isocyanate components are metered with a high pressure machine and mixed in a mixing head. Catalysts and/or blowing agents may be metered into the polyol mixture with separate pumps. The reaction mixture is applied to a continuously moving lower outerlayer. The lower outerlayer with the reaction mixture and the upper outerlayer enter the double belt in which the reaction mixture undergoes foaming and curing. After exiting the double belt the continuous strand is cut to the desired dimensions. This makes it possible to produce sandwich elements having metallic outerlayers or having flexible outerlayers. The upper and lower outer-layers which may be the same or different may be flexible or rigid outerlayers typically employed in double-belt processes. These include metal outerlayers such as aluminum or steel, bitumen outerlayers, paper, nonwoven fabrics, plastic sheets such as polystyrene, plastic films such as polyethylene films or wood outerlayers. The outerlayers may also be coated, for example with a conventional lacquer or an adhesion promoter. It is particularly preferable to employ outerlayers which are diffusion-resistant toward the cell gas of the rigid polyisocyanurate foam.

Such processes are known and described for example in “Kunststoffhandbuch, Band 7, Polyurethane”, Carl Hanser Verlag, 3rd edition 1993, chapter 6.2.2 or EP 2234732. The present invention finally provides a polyisocyanate-based rigid foam obtainable by a process according to the invention and a polyurethane sandwich element comprising such a polyisocyanate-based rigid foam according to the invention.

A polyisocyanate-based rigid foam according to the invention features exceptional mechanical properties, in particular an exceptional compressive strength coupled with reduced surface brittleness, which is apparent in particular through improved outerlayer adhesion in the production of sandwich elements in the continuous double-belt process. In addition, the polyisocyanate-based rigid foams according to the invention also exhibit exceptional flame retardancies using only small amounts of ecologically and toxicologically questionable flame retardants. The reaction mixtures used for producing the polyisocyanate-based rigid foams also make it possible to achieve the required reactivities coupled with improved foam curing using only small amounts of ecologically and toxicologically questionable catalysts.

The invention is elucidated hereinbelow with reference to examples.

### EXAMPLES

The following input materials were employed:
Polyesterol 1: Esterification product of phthalic anhydride, oleic acid and diethylene glycol having an average hydroxyl functionality of 1.75, a hydroxyl number of 215 mg KOH/g and an oleic acid content of 15% by weight.
Polyesterol 2: Esterification product of terephthalic acid, oleic acid, glycerol and diethylene glycol having an average hydroxyl functionality of 2.3, a hydroxyl number of 245 mg KOH/g and an oleic acid content of 18% by weight.
Polyesterol 3: Esterification product of phthalic anhydride, oleic acid and diethylene glycol having a hydroxyl functionality of 2.0 and a hydroxyl number of 240 mg KOH/g.
Polyetherol 1: Polyether polyol produced by ethoxylation of ethylene glycol having a hydroxyl functionality of 2 and a hydroxyl number of 190 mg KOH/g.
Polyetherol 2: Polyether polyol produced by ethoxylation of ethylene glycol having a hydroxyl functionality of 2 and a hydroxyl number of 225 mg KOH/g.
Polyetherol 3: Polyether polyol produced by ethoxylation of ethylene glycol having a hydroxyl functionality of 2 and a hydroxyl number of 280 mg KOH/g.
Polyetherol 4: Polyether polyol produced by ethoxylation of ethylene glycol having a hydroxyl functionality of 2 and a hydroxyl number of 750 mg KOH/g.
Polyetherol 5: Polyether polyol produced by ethoxylation of glycerol having a hydroxyl functionality of 3 and a hydroxyl number of 250 mg KOH/g.
Polyetherol 6: Polyether polyol produced by propoxylation of propylene glycol having a hydroxyl functionality of 2 and a hydroxyl number of 250 mg KOH/g.
Polyetherol 7: Polyether polyol produced by propoxylation of a mixture of sucrose and glycerol, having a hydroxyl functionality of 4.3 and a hydroxyl number of 490 mg KOH/g.
Polyetherol 8: Polyether polyol produced by ethoxylation of a mixture of sucrose and glycerol having a hydroxyl functionality of 4.8 and a hydroxyl number of 480 mg KOH/g.
Polyetherol 9: Polyether polyol consisting of 94% by weight of ethylene oxide and 6% by weight of propylene oxide having exclusively primary hydroxyl end groups, a functionality of 2 and a hydroxyl number of 190 mg KOH/g.
Polyetherol 10: Polyether polyol produced by ethoxylation of ethylene glycol having a hydroxyl functionality of 2 and a hydroxyl number of 115 mg KOH/g.
Flame retardant: Tris(2-chloroisopropyl) phosphate (TCPP)
Foam stabilizer: Tegostab B 8467 (silicone-containing foam stabilizer from Evonik)
Catalyst A: Catalyst consisting of 16.8% by weight of bis(2-dimethylaminoethyl) ether, 76% by weight of polyetherol 6 and 7.2% by weight of dipropylene glycol.
Catalyst B: Catalyst consisting of 40% by weight of potassium formate, 54% by weight of monoethylene glycol and 6% by weight of water.
Blowing agent A: Blowing agent mixture consisting of 85% by weight of formic acid and 15% by weight of water.
Blowing agent B: Blowing agent mixture consisting of 80 mol % of n-pentane and 20 mol % of isopentane.
Blowing agent C: Water
PMDI: Polymeric diphenylmethane diisocyanate (Lupranat M50 from BASF)

Using the described input materials the polyol components described in table 1 and 2, consisting of polyesterol 1-3, Polyetherol 1-10, flame retardant and foam stabilizer, were produced.

Phase stability and flowability testing of the polyol component

The polyol components thus produced were tested for phase stability and flowability at 20° C. by filling a small amount of polyol component into a transparent bottle directly after production and observing it for several days.

Foaming of the polyol components to afford rigid foams having comparable indexes, reactivities and foam densities

In addition, the polyol components were reacted using PMDI in a mixing ratio such that the isocyanate index of all foams produced was 340±10. The amount of flame retardants and the amount of foam stabilizer in the polyol component was selected such that, based on the foam, the amount of flame retardant and foam stabilizer was identical. Furthermore, the amount of flammable blowing agent B and trimerization catalyst B was selected such that, based on the foam, the content of these compounds too was identical. Through variation of blowing agent A/blowing agent C and catalyst A all foams were subsequently adjusted to comparable fiber times of 55 s±2 s and beaker foam densities of 41 kg/m³±1 kg/m³. To this end 80 g of reaction mixture were intensively mixed with a laboratory stirrer at 1400 rpm in a paper cup.

The reaction mixtures thus adjusted to comparable fiber times and densities were subsequently used to determine surface cure and foam brittleness values and to produce rigid foam blocks for further investigations.

### Surface Cure and Foam Brittleness Measurement

The surface cure of the laboratory foams adjusted to identical reaction times and foam densities was determined by the bolt test. A steel bolt with a spherical cap of 10 mm in radius was pressed 10 mm deep using a tensile/compressive testing machine into the foam mushroom resulting 2.5; 3; 4; 5; 6 and 7 minutes after intensive mixing of 80 g of reaction components (at 1500 rpm) in a 1.15 L polystyrene beaker. The maximum force in N required therefor is a measure of the cure of the foam at the particular time. Each cure measurement was carried out on a fresh foam site at the same distance to the foam edge.

As a measure of the brittleness of the rigid polyisocyanurate foam the time at which the surface of the rigid foam exhibited visible fracture zones in the bolt test (fracture in the bolt test) was determined. The earlier a visible fracture is apparent, the more brittle the foam. Foam fracture in the cure test is apparent from a C (=crack) in table 1 and 2.

Brittleness was also determined subjectively (subjective brittleness) 8 minutes after mixing the reaction components by pressing on the lateral upper edge of the foam and evaluated according to a grading system of 1 to 5. 1 means that the foam is hardly brittle, and 5 means that the foam exhibits a very high brittleness.

The foam brittleness was evaluated according to the following criteria using a grading system:
1. No brittleness: No foam cracks are evident and no cracking sounds are discernible upon pressing down on the foam
2. Slight brittleness: No foam cracks are evident but slight cracking sounds are discernible upon pressing down on the foam
3. Intermediate brittleness: Fine foam cracks are evident and clearly apparent cracking sounds are discernible upon pressing down on the foam
4. High brittleness: Clearly apparent foam cracks are evident and clearly apparent cracking sounds are discernible upon pressing down on the foam
5. High brittleness: Clearly apparent foam cracks including clearly apparent incidences of foam spalling are evident and marked clearly apparente cracking sounds are discernible upon pressing the foam

### Small Burner Test in Accordance with EN-ISO 11925-2

260 g of the reaction mixture adjusted to identical reaction times and foam densities were intensively stirred for 10 seconds at 1500 rpm in a paper cup using a laboratory stirrer and transferred into a box mold having internal dimensions of 25 cm×15 cm×22 cm (length×width×height). 24 hours after curing of the reaction mixture the resulting rigid foam block was demolded and shortened by 3 cm on all edges. The test specimens having the measurements: 190×90×20 mm were subsequently conditioned for 24 hours at 20° C. and 65% atmospheric humidity. 5 test specimens were taken from each rigid foam block and tested at the 90 mm edge by edge flaming according to DIN EN-ISO 11925-2. The average of the flame heights is reported as “Ø flame height, EN-ISO 11925-2” in tables 1 and 2.

### Determination of Compressive Strengths:

350 g of the reaction mixture adjusted to identical reaction times and foam densities were reacted to produce foam blocks in a plastic bucket having a diameter of 21 cm and a height of 20 cm by intensive mixing of the mixture at 1500 rpm with a laboratory stirrer for 10 seconds.

9 specimens having dimensions of 50 mm×50 mm×50 mm were subsequently taken from the foam blocks to determine compressive strength according to DIN EN 826. The specimens were always taken from the same sites. Of the 9 test specimens, 3 test specimens were rotated such that the test was carried out counter to the rise direction of the foam (top). Of the 9 test speci10 mens, 3 test specimens were rotated such that the test was carried out perpendicular to the rise direction of the foam (in the x-direction). Of the 9 test specimens, 3 test specimens were rotated such that the test was carried out perpendicular to the rise direction of the foam (in the y-direction). An average value was subsequently formed from all measured results and reported as “Ø compressive strength” in tables 1 and 2.

TABLE 1
Examples 1-7

| | | Exam- | Exam- | Exam- | Exam- | Exam- | Exam- | Exam- |
|---|---|---|---|---|---|---|---|---|
| | | ple | ple | ple | ple | ple | ple | ple |
| | | 1 | 2 | 3 | 4 | 5 | 6 | 7 |
| Polyesterol 1 | Parts | 55 | | | 54.5 | 54.65 | 54.4 | 55 |
| Polyesterol 2 | Parts | | 54.65 | | | | | |
| Polyesterol 3 | Parts | | | 54.65 | | | | |
| Polyetherol 1 | Parts | 35 | 34.75 | 34.75 | 34.65 | | | |
| Polyetherol 2 | Parts | | | | | 34.75 | | |
| Polyetherol 3 | Parts | | | | | | 34.55 | |
| Polyetherol 4 | Parts | | | | | | | |
| Polyetherol 5 | Parts | | | | | | | |
| Polyetherol 6 | Parts | | | | | | | |
| Polyetherol 7 | Parts | | | | | | | |
| Polyetherol 8 | Parts | | | | | | | |
| Polyetherol 9 | Parts | | | | | | | 35 |
| Polyetherol 10 | Parts | | | | | | | |
| Flame retardant | Parts | 8 | 8.5 | 8.5 | 8.7 | 8.5 | 8.85 | 8 |
| Foam stabilizer | Parts | 2 | 2.1 | 2.1 | 2.15 | 2.1 | 2.2 | 2 |
| Polyol component | Parts | 100 | 100 | 100 | 100 | 100 | 100 | 100 |
| PMDI | Parts | 220 | 240 | 240 | 250 | 240 | 255 | 220 |
| Catalyst B | Parts | 1.4 | 1.5 | 1.5 | 1.5 | 1.5 | 1.55 | 1.4 |
| Blowing agent A | | X | X | X | X | X | X | X |
| Blowing agent B | Parts | 11.5 | 12.3 | 12.3 | 12.2 | 12.2 | 12.8 | 11.5 |
| Blowing agent C | | | | | | | | |
| Polyesterol/polyetherol | | 1.57 | 1.57 | 1.57 | 1.57 | 1.57 | 1.57 | 1.57 |
| ratio | | | | | | | | |
| Catalyst B | % by | 0.41 | 0.41 | 0.42 | 0.42 | 0.42 | 0.41 | 0.41 |
| in foam | wt. | | | | | | | |
| Blowing agent B | % by | 3.40 | 3.40 | 3.42 | 3.39 | 3.40 | 3.42 | 3.4 |
| in foam | wt. | | | | | | | |
| Flame retardant in foam | % by | 2.35 | 2.36 | 2.36 | 2.37 | 2.36 | 2.37 | 2.35 |
| | wt. | | | | | | | |
| Index | | 348 | 339 | 349 | 350 | 348 | 338 | 346 |
| Phase stable | yes/no | yes | yes | yes | yes | yes | yes | yes |
| Flowable at 20° C. | yes/no | yes | yes | yes | yes | yes | yes | yes |
| Surface cure 2.5 min | [N] | 61 | 62 | 72 | 71 | 70 | 76 | 56 |
| Surface cure 3 min | [N] | 73 | 74 | 82 | 81 | 88 | 89 | 66 |
| Surface cure 4 min | [N] | 94 | 96 | 103 | 86 | 103 | 108 | 88 |
| Surface cure 5 min | [N] | 114 | 115 | 124 | 125 | 122 | 128 | 109 |
| Surface cure 6 min | [N] | 127 | 129 | 134 | 145 | 131 | 120 C | 120 |
| Surface cure 7 min | N | 143 | 141 | 143 | 162 | 133 | 143 C | 131 |
| Ø Surface cure | [N] | 102 | 103 | 110 | 112 | 108 | 111 | 95 |
| Foam brittleness after 8 min | 1-5 | 1 | 2 | 2 | 2 | 1 | 2 | 2 |
| Ø Flame height, EN-ISO | | 11.5 | 10.5 | 9.8 | 11.1 | 11.2 | 12.1 | 10.5 |
| 11925-2 | | | | | | | | |
| Ø Compressive strength | | 0.20 | 0.20 | 0.22 | 0.20 | 0.20 | 0.20 | 0.22 |

X) Use for density adjustment

TABLE 2
Comparative examples 1-6

| | | Com- | Com- | Com- | Com- | Com- | Com- | Com- | Com- | Com- |
|---|---|---|---|---|---|---|---|---|---|---|
| | | para- | para- | para- | para- | para- | para- | para- | para- | para- |
| | | tive | tive | tive | tive | tive | tive | tive | tive | tive |
| | | 1 | 2 | 3 | 4 | 5 | 6 | 7 | 8 | 9 |
| Polyesterol 1 | Parts | 51.1 | 53.9 | 51.8 | 51.4 | 79.65 | 55.65 | 55 | 54.65 | 79.65 |
| Polyesterol 2 | Parts | | | | | | | | | |
| Polyesterol 3 | Parts | | | | | | | | | |
| Polyetherol 1 | Parts | | | | | 10 | | 35 | | 10 |
| Polyetherol 2 | Parts | | | | | | | | 34.75 | |
| Polyetherol 3 | Parts | | | | | | | | | |
| Polyetherol 4 | Parts | 32.5 | | | | | | | | |
| Polyetherol 5 | Parts | | | | | | | | | |
| Polyetherol 6 | Parts | | 34.3 | | | | | | | |
| Polyetherol 7 | Parts | | | 32.95 | | | | | | |
| Polyetherol 8 | Parts | | | | 32.7 | | | | | |
| Polyetherol 9 | Parts | | | | | | | | | |
| Polyetherol 10 | Parts | | | | | | 35.3 | | | |
| Flame retardant | Parts | 13.2 | 9.5 | 12.2 | 12.7 | 8.3 | 7.2 | 8 | 8.5 | 8.3 |
| Foam stabilizer | Parts | 3.2 | 2.3 | 3.05 | 3.2 | 2.05 | 1.85 | 2 | 2.1 | 2.05 |
| Polyol component | Parts | 100 | 100 | 100 | 100 | 100 | 100 | 100 | 100 | 100 |
| PMDI | Parts | 420 | 270 | 370 | 390 | 230 | 190 | 220 | 240 | 230 |
| Catalyst B | Parts | 2.3 | 1.65 | 2.12 | 2.22 | 1.45 | | 1.4 | 1.5 | 1.45 |
| Blowing agent A | | X | X | X | X | X | X | | | |
| Blowing agent B | Parts | 19 | 13.6 | 17.6 | 18.3 | 12 | | 11.5 | 12.2 | 11.5 |
| Blowing agent C | | | | | | | | X | X | X |
| Polyesterol/Polyetherol | | 1.57 | 1.57 | 1.57 | 1.57 | 7.97 | 1.57 | 1.57 | 1.57 | 7.97 |
| ratio | | | | | | | | | | |
| Catalyst B | % by | 0.41 | 0.41 | 0.41 | 0.41 | 0.41 | — | 0.42 | 0.42 | 0.41 |
| in foam | wt. | | | | | | | | | |
| Blowing agent B | % by | 3.41 | 3.39 | 3.41 | 3.4 | 3.42 | — | 3.42 | 3.42 | 3.42 |
| in foam | wt. | | | | | | | | | |
| Flame retardant in | % by | 2.37 | 2.37 | 2.36 | 2.36 | 2.36 | 2.35 | 2.38 | 2.38 | 2.37 |
| foam | wt. | | | | | | | | | |
| Index | | 337 | 340 | 341 | 342 | 337 | — | 337 | 335 | 335 |
| Phase stable | yes/no | yes | yes | yes | no | yes | no | yes | yes | yes |
| Flowable at 20° C. | yes/no | yes | yes | yes | yes | yes | no | yes | yes | yes |
| Surface cure 2.5 min | [N] | 72 | 37 C | 42 C | Severe | 47 | Not | 47 | 58 | 48 |
| Surface cure 3 min | [N] | 84 | 47 C | 54 C | foam | 57 | foam- | 58 | 70 | 59 |
| Surface cure 4 min | [N] | 100 C | 69 C | 73 C | shrink- | 77 C | able | 73 | 88 | 78 C |
| Surface cure 5 min | [N] | 106 C | 87 C | 92 C | age | 91 C | at | 86 | 100 | 92 C |
| Surface cure 6 min | [N] | 111 C | 105 C | 105 C | No | 106 C | room | 99 | 109 | 107 C |
| Surface cure 7 min | [N] | 122 C | 115 C | 110 C | meas- | 116 C | tem- | 101 | 117 | 118 C |
| Ø Surface cure | [N] | 99 | 77 | 79 | ure- | 82 | pera- | 77 | 90 | 83 |
| Foam brittleness after | 1-5 | 5 | 5 | 5 | ment | 5 | ture | 1 | 1 | 5 |
| 8 min | | | | | possi- | | since | | | |
| Ø Flame height, EN- ISO 11925-2 | | 11.5 | 15.8 | 15.2 | ble | 12.3 | not | 11.5 | 11 | 12 |
| Ø Compressive strength | | 0.21 | 0.19 | 0.21 | after | 0.21 | flowa- | 0.18 | 0.18 | 0.20 |
| | | | | | short | | ble | | | |
| | | | | | time | | | | | |

X) Use for density adjustment

As is apparent from table 1 and 2, the combination of polyester polyol (b1) and polyether polyol (b2) results in particularly advantageous polyol components and rigid polyisocyanurate foams when the mass ratio of the component (b1) to component (b2) is in the inventive range. Thus, all polyol components of examples 1-7 are phase stable and flowable at 20° C. Surprisingly, the curing of the rigid polyisocyanurate foams corresponding to examples 1-7 is significantly improved relative to all comparative examples, thus allowing faster processing in production plants and thus significantly increasing productivity. Surprisingly, all foams from example 1-7 additionally exhibit a markedly reduced foam brittleness at the surface, and it is known from experience that this results in improved foam adhesion to outerlayer materials and improved temperature change resilience of the sandwich elements produced therewith.

It is also apparent that all inventive rigid polyisocyanurate foams corresponding to examples 1-7 retain very good compressive strength despite the reduced foam brittleness. Even with little flame retardant based on the foam, all inventive rigid polyisocyanurate foams pass the small burner test with a flame height <11.5 cm.

However, a deviation from the inventive formulation results in disadvantages in the properties of the polyol components or the rigid foams.

Thus, for example, an increase in the mass ratio of component (b1) to component (b2) results in a marked impairment of foam curing and a marked increase in foam brittleness, as well as a slight impairment of fire retardancy (comparative example 5).

Substitution of the inventive polyether polyol (b2) with a noninventive polyether polyol likewise results in impairment. Thus, by reference to the polyethylene glycols used, comparative example 1 and comparative example 6 show that an optimal degree of ethoxylation is achieved for the polyether polyol (b2). An excessively low degree of the consolation (comparative example 1) results in a marked increase in foam brittleness. An excessively high degree of ethoxylation (comparative example 6) results in a solidification of the polyol component at room temperature, thus precluding foaming.

Substituting the inventive predominantly alkoxylated polyether polyol (b2) with a propoxylated polyether polyol (comparative example 2) results in a marked reduction in foarm curing, a marked increase in flame height according to EN-ISO 11925-2 and a marked increase in foam brittleness.

The use of higher-functional propoxylated and ethoxylated polyether polyols (comparative examples 3 and 4) also results in impaired foam properties relative to inventive polyether polyols (b2).

In comparative examples 7 and 8 the formic acid-water mixture (blowing agent A) of examples 1 and 5 was replaced with water (chemical blowing agent C) as the sole chemical blowing agent. This results in each case in significant impairment of foam curing, in impairment of the foam compressive strengths and in increased bubble formation on the surface of the beaker foams. By contrast, changing to water as the blowing agent in the case of noninventive polyol components with an increased mass ratio of component (b1) to component (b2) (comparative example 9) does not result in a significant change in foam curing and compressive strength relative to comparative example 5.

Only the combination of input materials described in examples 1-7 makes it possible to produce reaction mixtures meeting all requirements.

1. A process for producing rigid polyisocyanate foams, wherein
(A) polyisocyanates are mixed with
(B) compounds having isocyanate-reactive hydrogen atoms
(C) flame retardant
(D) blowing agent
(E) catalyst and
(F) optionally further auxiliary and additive substances
at an isocyanate index of at least 220 to afford a reaction mixture and cured to afford the rigid polyisocyanurate foam,
wherein the component (B) comprises at least one aromatic polyester polyol (b1) and at least one polyether polyol (b2), wherein the polyester polyol (b1) is produced by esterification of:
(b1.1) 10 to 50 mol % of a dicarboxylic acid composition comprising aromatic dicarboxylic acids,
(b1.2) 0 to 20 mol % of one or more fatty acids and/or fatty acid derivatives,
(b1.3) 10 to 80 mol % of one or more aliphatic or cycloaliphatic diols having 2 to 18 carbon atoms or alkoxylates of same,
(b1.4) 0 to 50 mol % of a higher-functional polyol selected from the group consisting of glycerol, alkoxylated glycerol, trimethylolpropane, alkoxylated trimethylolpropane, pentaerythritol, alkoxylated pentaerythritol,
the total amount of the components (b1.1) to (b1.4) sums to 100 mol % and the aromatic polyester polyol (b1) has an average functionality of ≤ 3.0 and ≥ 1.7
and wherein the polyether polyol (b2) has a hydroxyl number of 160-350 mg KOH/g and is produced by alkoxylation of a starter or starter mixture having an average functionality ≤ 3.5 and ≥ 1.5,
wherein as the alkylene oxide for producing polyether polyol (b2) at least 80% by weight of ethylene oxide is employed and polyether polyol (b2) comprises at least 90% primary hydroxyl end groups and at most 10% secondary hydroxyl end groups,
wherein the mass ratio of the component (b1) to component (b2) is ≤ 3 and ≥ 1 and the sum of the mass fractions of component (b1) and component (b2), based on component (B), is >80% by weight,
and the blowing agent (D) comprises chemical and physical blowing agents, wherein the chemical blowing agent is selected from the group consisting of formic acid-water mixtures and formic acid.

2. The process according to claim 1, wherein the aromatic polyester polyol (b1) has an OH number of 190 to 250 mg KOH/g and a functionality of 1.7 to 2.5.

3. The process according to either of claims 1 to 2, wherein the aromatic polyester polyol (b1) comprises 5 to 15 mol % of one or more fatty acids and/or fatty acid derivatives.

4. The process according to any of claims 1 to 3, wherein exclusively diethylene glycol is used as the diol having 2 to 18 carbon atoms (b1.3).

5. The process according to any of claims 1 to 4, wherein the content of (b1.4) is 0 mol %.

6. The process according to any of claims 1 to 5, characterized in that 2-50 mol % of glycerol or ethoxylated glycerol is used as component (b1.4).

7. The process according to any of claims 1 to 6, wherein the polyether polyol (b2) has a hydroxyl number of 170-290 mg KOH/g.

8. The process according to any of claims 1 to 7, wherein the polyether polyol (b2) is produced by alkoxylation of a starter or starter mixture having an average total functionality of ≤3 and ≥2.

9. The process according to any of claims 1 to 8, wherein the polyether polyol (b2) is obtained by ethoxylation of diethylene glycol.

10. The process according to any of claims 1 to 9, wherein the flame retardants (C) comprise a phosphorus-containing flame retardant and the content of phosphorus, based on the total weight of the components (A) to (F), is <0.4% by weight.

11. The process according to any of claims 1 to 10, wherein the catalyst (E) comprises at least one amine catalyst having a tertiary amino group selected from the group consisting of pentamethyldiethylenetriamine and bis(2-dimethylaminoethyl) ether and at least one alkali metal carboxylate catalyst selected from the group consisting of potassium formate, potassium acetate and potassium 2-ethylhexanoate.

12. The process according to any of claims 1 to 11, wherein the reaction mixture is applied to a continuously moving outerlayer in a double-belt plant for producing sandwich elements.

13. A polyol component for producing rigid polyisocyanurate foams, comprising:
70% to 90% by weight of the compounds having at least 1.7 isocyanate-reactive hydrogen atoms (B),
2% to 10% by weight of flame retardant (C),
1% to 20% by weight of blowing agent (D),
0.5% to 10% by weight of catalysts (E) and
0.0% to 20% by weight of further auxiliary and additive substances (F),
in each case based on the total weight of the components (B) to (F), wherein the % by weight values sum to 100% by weight and wherein the components (B) to (F) are defined as in any of claims 1 to 11.

14. A rigid polyisocyanurate foam obtainable by the process according to one or more of claims 1 to 12.
